(19) United States
(12) Patent Application Publication
(10) Pub. No.: US 2013/0269798 A1
(43) Pub. Date: Oct. 17, 2013

(54) PROGRAMMABLE INTELLIGENT CONTROL METHOD OF AND SYSTEM FOR IRRIGATION SYSTEM

(71) Applicant: Kevin James Wood, Cypress, TX (US)

(72) Inventor: Kevin James Wood, Cypress, TX (US)

(21) Appl. No.: 13/444,101

(22) Filed: Apr. 11, 2012

(51) Int. Cl. F16K 37/00

(52) U.S. Cl. 137/551

(57) ABSTRACT

The present invention relates to an intelligent system for managing a plurality of flow control devices of the irrigation systems in one or multiple watering zones. In the preferred embodiment, the system of the present invention utilizes speech control technology known in the art to allow users to input operation commands directly into the controller or remotely through a remote control. The system further comprises a weather device which receives weather forecast information transmitted from wireless remote device and transmits said weather forecast to the controller as parameters to determine whether the preset watering cycle should be continued or suspended. The system further comprises flow sensor and will send alert message to user's mobile phone if the flow sensor detects excessive water flow. It will also send other text message to remind the user about water flow adjustment due to season changes and time for applying fertilizer.

### BACKGROUND OF THE INVENTION

1. Field of the Invention

The present invention relates to control systems and methods for irrigation systems and more particularly to a programmable intelligent system and method for managing the operation of water flow control devices of the irrigation systems.

2. Description of Related Art

Automatic irrigation systems in yards, farms, and greenhouses for providing gardening and agriculture are known in the art. Typically, irrigation systems utilize automatic controllers to control the watering cycles. Some of the automatic controllers execute watering cycles regardless of the weather or environmental conditions, such as rain precipitation, wind, and/or temperature conditions. They rely on operator to manually suspend the watering cycle. However, the operator may forget to cancel the watering cycle and thus lead to water and money waste or damage gardening or agriculture. The operators may forget to resume the watering cycle after the watering cycle is suspended. Therefore, there are automatic controllers that control irrigation based on weather and/or environmental conditions.

More specifically, by way of example, U.S. Pat. No. 7,769,494 to Simon et al. discloses a method for automatically adjusting the amount of water supplied by a water timer which comprises a user interface and a controller coupled to the user interface and programmed to provide control signals for controlling a plurality of flow control devices, each flow control device capable of controlling the passage of water from a water source to a watering zone. The method comprises sensing a base ambient temperature/humidity and providing the base ambient temperature/humidity signal to the controller, subsequently sensing a current ambient temperature/humidity and providing the base ambient temperature/humidity signal to the controller water timer, and modifying the watering amount according to the base and current ambient temperature/humidity signals.

U.S. PreGrant Publication No. 2009/0008471 to Wilson discloses control devices for irrigation systems and the associated methods for making and using such devices to control irrigation systems. The control devices contain a timer that can be mounted to a fixed location that is remote from a plurality of valves for the sprinkler system. The timer receives instructions that can be entered directly into the timer or the instructions can be entered remotely using another remote interface tool, such as a wirelessly connected personal computer or radio frequency (RF) programming device.

U.S. PreGrant Publication No. 2009/0008472 to Wilson discloses a control device for an irrigation system, comprising a timer connected to a plurality of irrigation valves, the timer containing an interactive display screen with a plurality of interactive programming elements, the plurality of irrigation valves being controlled by the interactive programming elements which are capable of setting any given function for the irrigation valves with a single selection by a user.

U.S. PreGrant Publication No. 2011/0238230 to Rung discloses a regulator system for regulating the operation of an irrigation system which is responsive to user programmed information. It has a control element for issuing watering control signals to an irrigation system, having at least one of (i) duration programming device for programming a minimum amount of time and a maximum amount of time for the suspension of watering by the irrigation system, and (ii) a user adjustable temperature programming device for programming a minimum allowed temperature for initiating a watering period by the irrigation system. The regulator system comprises a control element for issuing watering control signals to an irrigation system comprising a rainfall detection sensor and rainfall accumulation sensor.

The above mentioned control systems utilize humidity sensors, temperature sensors, rain sensors to determine whether or not to water. Neither of them utilizes modern speech control technology to allow user to input operation commands either.

It would be advantageous for the operator to be able to utilize weather forecast information received from wireless remote device and/or internet so that no temperature sensor or humidity sensor or rain water sensor is needed. The system can utilize the weather center information to shut off the watering or resume the watering. Moreover, it would be advantageous if the system also provides flow sensor to detect excessive water flow which may be caused by broken sprinkler head, broken pipe or electrical fault in irrigation system and sends alarm messages to user's mobile phone so as to prevent unexpected water flood or to have reminder of applying seasonal fertilizer. Speech control technology is a growing technology and can simplify the user input without going through pages of screen display.

### SUMMARY OF THE INVENTION

One object of the present invention is to provide a system for controlling irrigation system using speech control technology in simplifying user input.

Another object of the present invention is to provide a system and method to control irrigation system using weather center information.

Another object of the present invention is to provide a system and method to control irrigation system meanwhile monitoring water flow to prevent unexpected flood.

Another object of the present invention is to provide a system and method to control irrigation system using wireless remote control.

A further object of the invention is to provide a system and method that will send user's mobile phone text message to alarm/alert the user.

The present invention relates to an intelligent method of and system for managing a plurality of flow control devices of the irrigation systems in one or multiple watering zones. The present system comprises a water timer controller, weather device, and remote control device. The timer controller comprises a programmable logics controller (“PLC” hereinafter) associated to a user interface which utilizes speech control technology known in the art. The system provides centralized control of the irrigation system located in one or multiple watering zones. It reduces labor dedicated to operation of zones separately. The timer controller is programmed to provide control signals (electrical current) through electrical wires that turn on or off the flow control devices typically electrochemical valves/switches of the irrigation systems (e.g. sprinkler, etc.) located in one or multiple watering zones thus controlling the passage of water from water source to said watering zones.

The timer controller receives operation commands that can be entered directly into the timer or remotely using a remote control device. Thus, the system can be easily programmed away from the timer controller when it is mounted at a fixed location may be in a distant farming zone. In the preferred embodiment, the system of the present invention utilizes speech control technology known in the art to allow users to input operation commands directly into the timer controller or remotely through a remote control. In other embodiments, a touch screen or conventional push buttons may be used to operate the system.

The system of the present invention further comprises a weather device which receives weather forecast information transmitted from weather centers and transmits said weather forecast to the timer controller as parameters to determine whether the preset watering cycle should be continued or suspended. The weather device utilizes radio frequency antenna to receive and transmit the weather forecast data. In another embodiment, the weather forecast information may be updated via the internet through a software program on a computer. A USB transmitter 22 connected to the computer 23 will transmit the weather forecast information to the weather device 4 using radio frequency or other appropriate technology known in the art. The weather device 4 will then transmit the weather forecast to the timer controller 2 using radio frequency or other appropriate technology known in the art.

The system of the present invention further comprises a flow sensor to detect water flow amount and send “excessive water flow” message to user's mobile phone to alert the user. The system of the present invention will also send other text messages to user's mobile phone to remind the user about water flow adjustment and application of fertilizer due to seasonal changes.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of an intelligent managed irrigation control system according to an embodiment of the present invention comprising a timer controller device and a remote control transmitter device.

FIG. 2A and FIG. 2B are front views of a weather forecast receiver device according to an embodiment of the present invention showing a normal condition when the forecast is sunny (FIG. 2A) and a shut off condition when the forecast is cloudy or rain (FIG. 2B).

FIG. 3 is a perspective view showing the weather device received weather forecast information from a computer USB transmitter.

FIG. 4 is a flow chart showing the process that one embodiment of the system of the present invention turns the irrigation system off or on based on the weather forecast information received from the weather center through radio frequency antenna.

FIG. 5 is a wiring back plate electrical interface according to an embodiment of the present invention which holds all three devices (fixed timer controller, fixed weather device, and remote control transmitter device).

FIG. 6 is a rear view (top) of the timer controller showing electrical contact pins and radio frequency remote control antenna and backup batteries and a top view (bottom) showing a reset button.

### DESCRIPTION OF THE PREFERRED EMBODIMENT

The present invention relates generally to an intelligent control system used to manage the operation of flow control devices, typically solenoid-actuated valves and pump relays for irrigation systems such as sprinkler devices and other watering devices.

One of the embodiments of the intelligent control system 1 according to the present invention comprises a timer controller 2, a portable remote control 3, a weather device 4, and a wiring back plate 5. The timer controller 2 has a plurality of electrical contact pins on its back for electrically connecting to the wiring back plate 5 which has an electrical interface comprising a plurality of ports for connecting to a plurality of electromechanical valves/switches of irrigation system to control these irrigation system.

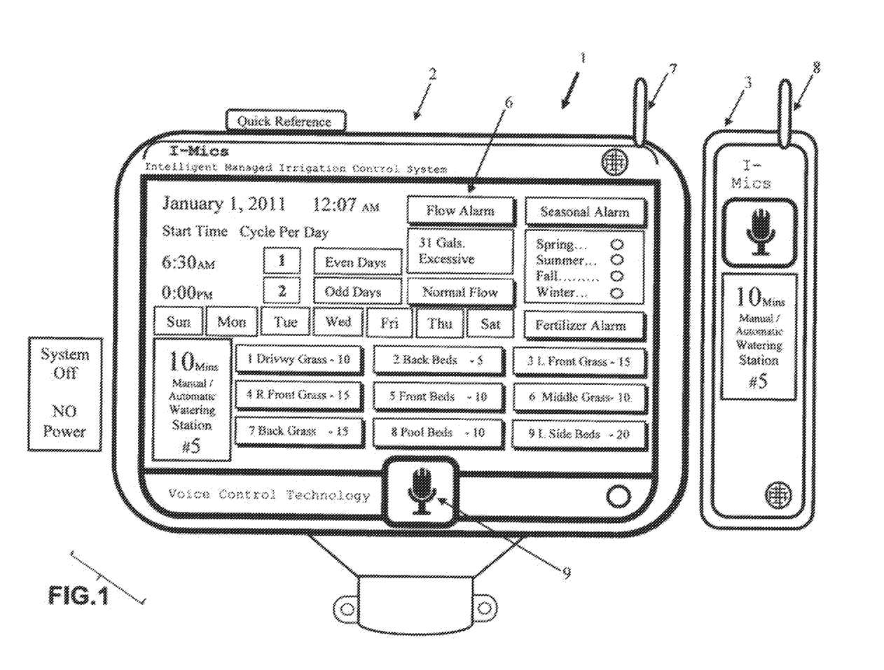

The timer controller 2 includes a user interface and a PLC that has a control program to control the operation of flow control devices, typically electromechanical valves/switches including but not limited to solenoid-actuated valves for irrigation systems in one or more watering or irrigation zones by sending electrical control signals to the corresponding electromechanical valves. Because the timer controller 2 contains memory so in the event of a complete power failure, the control program will not be lost. The timer controller 2 further comprises a LED or LCD 6 screen on the front, which displays total system information in multiple color tiles along with numerical, texts for quick and easy identification of all system functions as shown in FIG. 1.

The timer controller 2 may further comprise speech control technology known in the art to allow users to input operation commands.

In the preferred embodiment, the invention uses only “Speech Control Technology” to allow users to program all settings and operational functions. In another embodiment, the invention allows users to select pre-programmed operational functions by pushing buttons or touching icons. The timer controller 2 also comprises a radio frequency (RF) receiver antenna 7 which allows timer controller 2 to receive input from the remote control 3 from RF remote control antenna 8. A user may carry the RF remote control 3 separately which has a user interface and a RF transmitter and can transmit programming instructions and manual operation commands via RF transmission to the timer controller 2. This configuration allows the user to program the timer controller 2 remotely. In the preferred embodiment, both the timer controller 2 and the remote control 3 utilizes speech control technology known in the art to allow users to input operation command. The timer controller 2, remote control 3 and weather device 4 further comprise timing device so they can synchronize with each other.

Referring to FIG. 1, the LED or LCD screen 6 displays icons to show seasonal alarm, fertilizer alarm and flow alarm. The PLC can be programmed to give off three types of alarms: seasonal, fertilizer, and flow sensor. The alarms will beep and blink red at the time of watering adjustments (due to season changes), when a different fertilizer should be applied, and when excessive water flow is detected (which may be caused by broken sprinkler head, broken pipe or electrical fault in irrigation system). The system's app (e.g. “i-Mics app”) may be downloaded to a user's smart phone to receive from the system (i-Mics) 1 the weather data along with alarms and text messages informing the user the cause of the alarm. In one embodiment, the system 1 is programmed to send the user 2 cell phone text massages (at that time of alarm and 12 hours late) indicating that the alarm has gone off due to one or more of these factors: wind speed, rain forecast, time for fertilizer application, rain or excessive water flow. The flow sensor alarm will continue to blink red until the cause of alarm is repaired and canceled by user.

The system 1 utilizes speech control technology for user to program the timer controller 2. In the preferred embodiment, the user utilizes the speech control technology by first touching the “I-Mic button” 9, after 1 flash and 1 beep sound; the user speaks command “SET” to program the timer controller. For example:
“SET water days . . . Sunday, Tuesday, Thursday and Saturday”
“SET start time 6:30 AM”
“SET runtime 10 minutes station 5”

To get water usage information, the user can speak:
“Water used last 30 days”
“Average water used per day”

After each said commands, the timer will give off 2 beeps sound and 2 green flashes to confirm user's said commands and user's said command will be displayed on the screen.

The system 1 further comprises a built-in automatic motion sensor (not shown) to activate illumination of the screen for the timer controller 2, and weather device 4, said motion sensor will shut-off illuminated screen if no movement is detected within a pre-set time period, preferably 30 seconds.

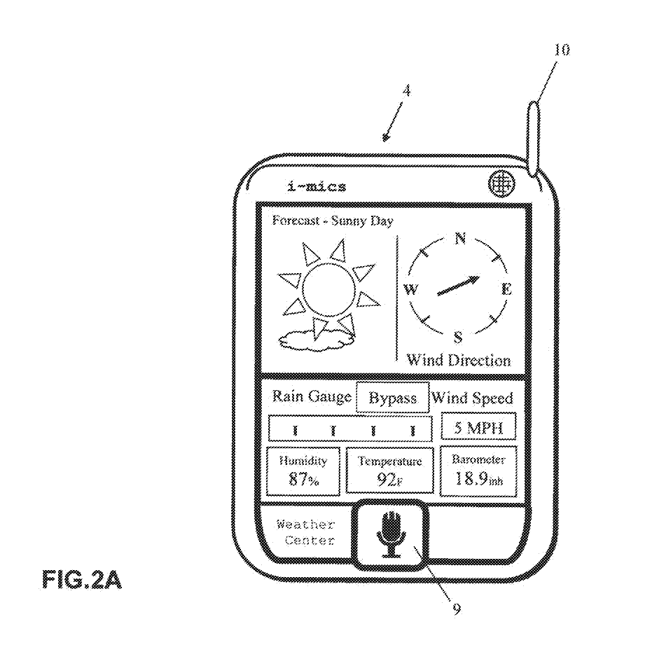

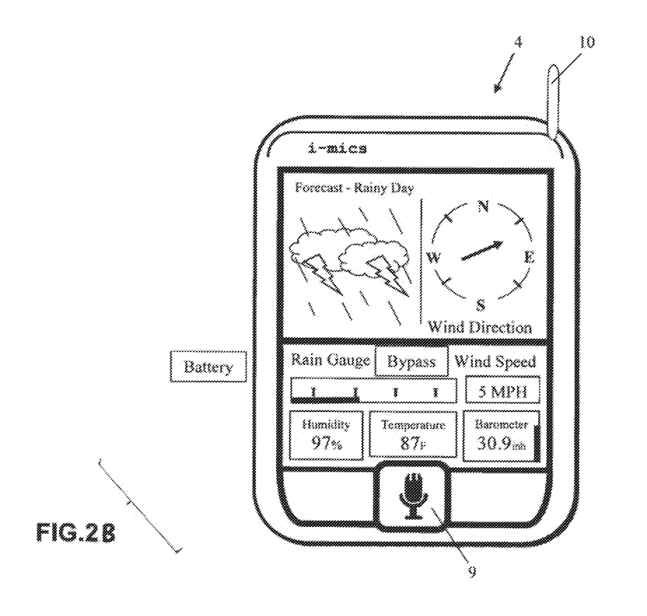

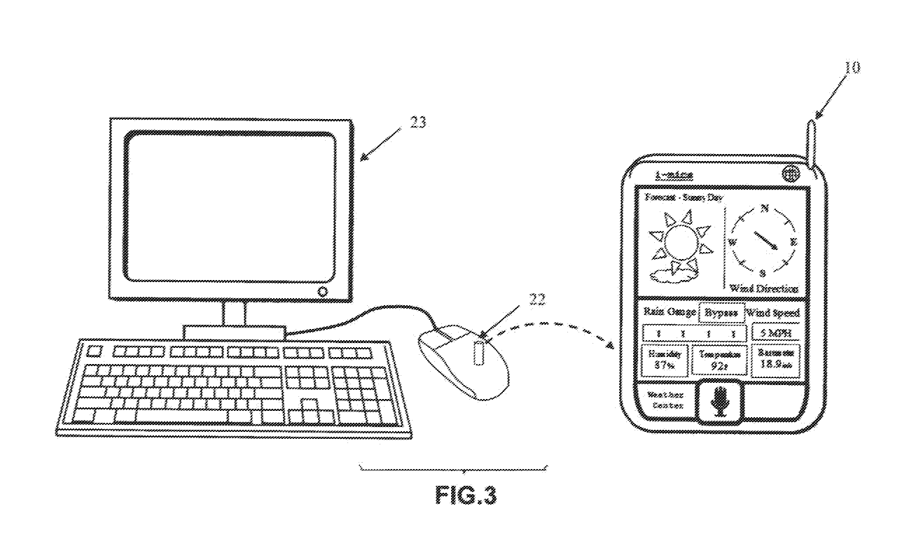

Referring to FIG. 2A and FIG. 2B, there is disclosed a wireless weather device 4 that transmits weather forecast information such as wind speed/direction, rainfall amount, humidity, temperature and barometric readings through radio frequency (RF). The weather forecast information may be updated via the internet through a software program on a computer. As shown in FIG. 3, a USB transmitter 22 connected to the computer 23 will transmit the weather forecast information to the weather device 4 using radio frequency or other appropriate technology known in the art. The weather device 4 will then transmit the weather forecast to the time controller 2 using RF transmitter 10. The timer controller 2 will either stop watering or water based on the weather forecast data it receives.

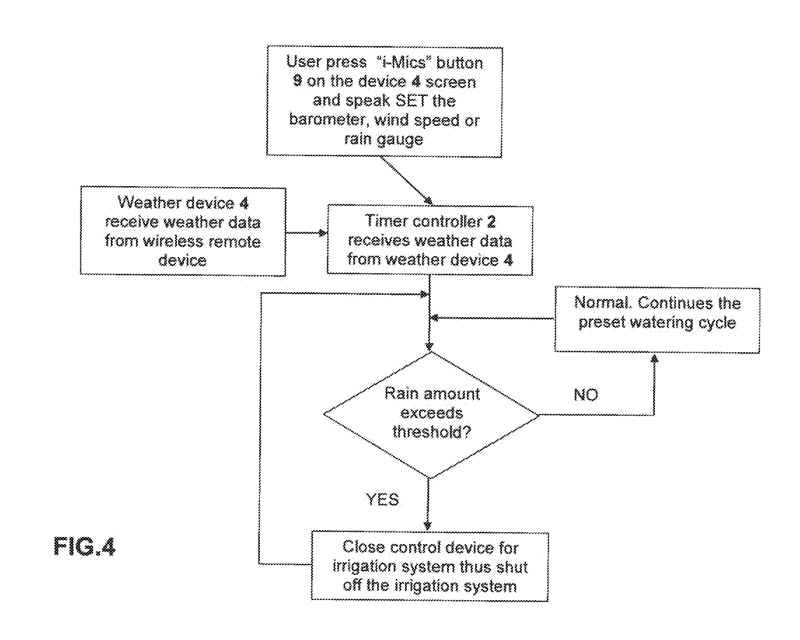

The weather device 4 receives weather forecast that includes: barometric measurements, wind speed measurements, and rainfall measurements. The weather device 4 may be set via the iMics button 9 to tell the timer controller 2 to turn off the watering process when the forecasted rainfall measurements exceed a rain gauge limit. For example, the rain gauge limit may be set at ⅛ inch, ¼ inch, ½ inch, or 1 inch. If the forecast is sunny, the weather center 4 screen displays a sun indicating a normal condition (FIG. 2A). If the forecast is cloudy and rain, the weather center screen displays rain shut-off conditions (FIG. 2B). The weather center 4 will transmit the weather information and the operation commands to the timer controller 2 as parameters to further control the operation of the irrigation system as illustrated in in FIG. 4.

This unique feature of the present invention takes advantage of the modern weather forecast capability and wave the need of having to have additional temperature sensor or rain or humidity sensor that is utilized in other devices for irrigation control disclosed in the foregoing related art section. In another embodiment, the weather device 4 may be combined with the timer controller 2 as one unit.

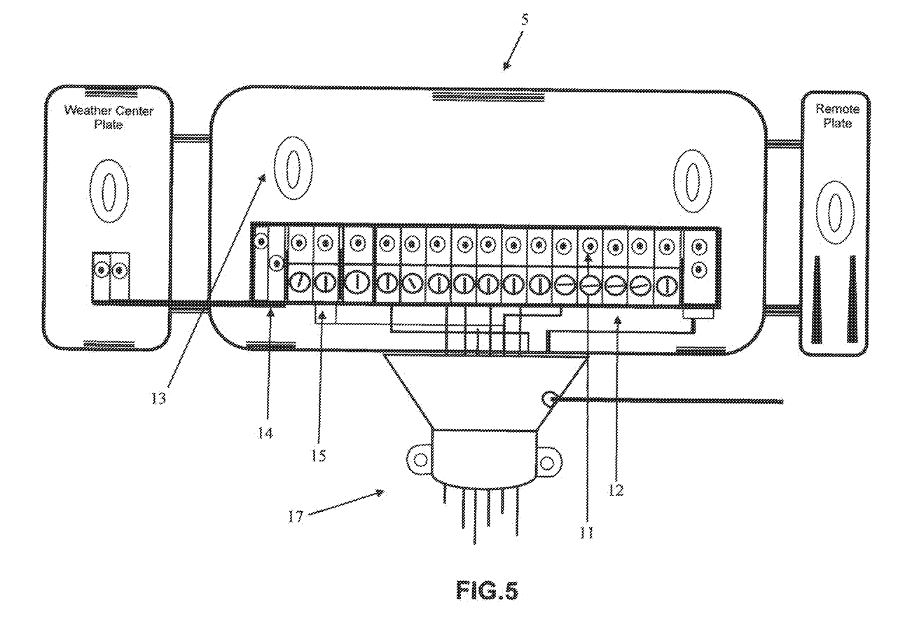

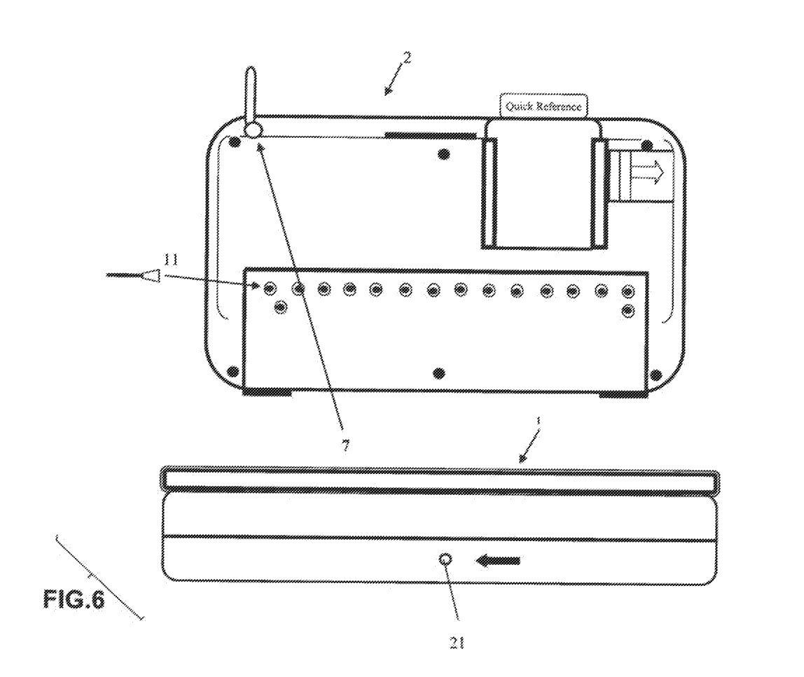

Referring to FIGS. 5 and 6, the timer controller 2 has a plurality of electrical contact pins 11 on its back which are designed for electrically connecting to the electrical contact pins socket on the wiring back plate 5, which further has a plurality of port 12 designed for connecting to a plurality of valves/switches of the flow control devices to control the irrigation system. When the timer controller 2 is mounted onto the wiring back plate 5 via the mounting eyes 13 and the electrical contact pins 11 are inserted into the corresponding sockets 12, the timer controller 2 can control the corresponding valves/switches of the flow control device for the irrigation system. The wiring back plate 5 also comprises an electrical contact pin sockets 14 for the weather center 4 and an electrical contact pin socket 15 for the flow sensor (not shown). The flow data collected from the flow sensor may help timer controller 2 to determine whether there is excessive water flow which may be caused by broken sprinkler head or broken pipe or electrical fault in irrigation system and send alarm text messages to the user's mobile phone in time to alert the user and prevent further over-watering or flood.

In one embodiment, the system 1 is programmed to send the user 2 cell phone text massages (at that time of alarm and 12 hours late) indicating that the alarm has gone off due to one or more of these factors: wind speed, rain forecast, time for fertilizer application, rain or excessive water flow. The flow sensor alarm will continue to blink red until the cause of alarm is repaired and canceled by user.

The wiring back plate 5 is mounted in a fixed location. The wiring that connects to the flow control device (for example electromechanical valves for irrigation system) goes through the conduit bracket 17. There is a reset button 21 on the top of the timer controller 2 in this embodiment for resetting the timer controller to default settings.

The intelligent control system 1 of the present invention may further comprise a flow sensor which is a versatile remote transmitter capable of accurately measuring flow rates. The intelligent control system 1 may further comprise control device (electromechanical valves/pumps) for the irrigation system.

The method of or arrangement of wiring or connecting the above electronic components and mounting them will be well known to those with ordinary skill in the electronic and mechanical arts.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An intelligent irrigation control system comprises:
a timer controller comprising:
a LED or LCD interface display screen on the front of said timer controller, which displays total system information in multiple color tiles for quick and easy identification of all system functions,
a plurality of electrical contact pins on the back of said timer controller,
a programmable logics controller that controls the operation of a plurality of electromechanical valves for irrigation systems, said programmable logics controller displays information on said LED or LCD screen,
a radio frequency receiver antenna;
a wireless weather device which uses radio frequency antenna to receive weather forecast information and transmits said information to said timer controller;
a portable remote control comprising a radio frequency transmitter antenna for user to input commands to program the timer controller; and
a wiring back plate for receiving said timer controller, weather device, and remote control device through mounting eyes having electrical contact pin sockets for receiving electrical contact pins of said timer controller and weather device and remote control, said wiring back plate further having a power supply and a plurality of ports for receiving electrical wiring that connects to a plurality of electromechanical valves/switches of flow control device for irrigation systems;
wherein said timer controller sends electrical signals according to preset programs or operator's commands to said electromechanical valves/switches for irrigation systems to control the operation of irrigation systems.

2. The intelligent irrigation control system of claim 1 further comprises a flow sensor which is a versatile remote transmitter capable of accurately measuring flow rates, said flow sensor is electrically connected to said electrical interface on said wiring back plate and provides said measuring flow rate data to said timer controller.

3. The intelligent irrigation control system of claim 1 further comprises a speech recognition device used to receive and recognize user's command and interact with said programmable logics controller to program said timer controller.

4. The intelligent irrigation control system of claim 1 wherein said LED or LCD screen displays seasonal alarm for seasonal watering adjustments, fertilizer alarm for fertilizer application, and flow sensor alarm for excessive-water flow.

5. The intelligent irrigation control system of claim 1 wherein said controller can be programmed to give off three types of alarms: seasonal, fertilizer, and flow sensor, said alarms will beep and the color tile display will illuminate red at the time of watering adjustments, when a different fertilizer should be applied, and when excessive water flow is detected.

6. The intelligent irrigation control system of claim 1 wherein the user needs to download the system's app (e.g. “i-Mics app”) to the user's smart phone to receive text messages informing the user the cause of the alarm or weather data that will cause the timer device to shut-off.

7. The intelligent irrigation control system of claim 2 wherein said flow sensor is a wired mechanical flow sensor which receives flow data such as gallons per hour, daily average calibrated to determine “NORMAL WATER FLOW”.

8. The intelligent irrigation control system of claim 1 wherein said controller is programmed to send the user mobile phone text massages indicating that the alarm has gone off due to one or more of these factors: wind speed, rain forecast, time for fertilizer application, rain or excessive water flow.

9. The intelligent irrigation control system of claim 1 further comprises at least one battery.

10. The intelligent irrigation control system of claim 1 further comprises a reset button for resetting said timer controller to default settings.

11. The intelligent irrigation control system of claim 1 wherein said timer control keeps irrigation systems on if the weather forecast is sunny and shuts off irrigation system if the forecasted rain exceeds preset threshold.

12. The intelligent irrigation control system of claim 1 further comprises a built-in automatic motion sensor to activate illumination of display screen to said timer controller and weather device, said motion sensor will shut-off illuminated display screen if no movement is detected within a preset time period.

13. The intelligent irrigation control system of claim 14 further comprises software program that enables a computer to receive updated weather forecast data through internet and transmit said weather forecast data through a USB transmitter that is connected to said wireless weather device.

14. An irrigation system comprising:
a timer controller comprising:
a LED or LCD interface display screen on the front of said timer controller, which displays total system information in multiple color tiles for quick and easy identification of all system functions,
a plurality of electrical contact pins on the back of said timer controller,
a programmable logics controller that controls the operation of a plurality of electromechanical valves for irrigation systems, said programmable logics controller displays information on said LED or LCD screen,
a radio frequency receiver antenna,
a wireless weather device which uses radio frequency antenna to receive weather forecast information and transmits said information to said timer controller;
a portable remote control comprising a radio frequency transmitter antenna for user to input commands to program the timer controller; and
a wiring back plate for receiving said timer controller, weather device, and remote control device through mounting eyes having electrical contact pin sockets for receiving electrical contact pins of said timer controller and weather device and remote control, said wiring back plate further having a power supply and a plurality of ports for receiving electrical wiring that connects to a plurality of electromechanical valves/switches of flow control device for irrigation systems; and
a plurality of electromechanical valves/switches of flow control devices for irrigation systems;
wherein said timer controller sends electrical signals according to preset programs or operator's commands to said electromechanical valves/switches for irrigation systems to control the operation of irrigation systems.

15. The intelligent irrigation control system of claim 14 further comprises a speech recognition device used to receive and recognize user's command and interact with said plc to program said timer controller.

16. The intelligent irrigation control system of claim 14 wherein said controller can be programmed to give off three types of alarms: seasonal, fertilizer, and flow sensor, said alarms will beep and the color tile display will illuminate red at the time of watering adjustments, when a different fertilizer should be applied, and when excessive water flow is detected.

17. The intelligent irrigation control system of claim 14 wherein said timer controller will forward a text message to the user's mobile phone to inform the user of cause of alarm.

18. The intelligent irrigation control system of claim 14 wherein the timer control keeps irrigation system on if the weather forecast is sunny and shuts off irrigation system if the forecasted rain exceeds preset threshold.

19. The intelligent irrigation control system of claim 14 wherein the user needs to download the system's app (e.g. “i-Mics app”) to the user's smart phone to receive text messages informing the user the cause of the alarm or weather data that will cause the timer device to shut-off.

20. The intelligent irrigation control system of claim 14 further comprises software program that enables a computer to receive updated weather forecast data through internet and transmit said weather forecast data through a USB transmitter that is connected to said wireless weather device.
